(19) United States
(12) Patent Application Publication
(10) Pub. No.: US 2007/0186528 A1
(43) Pub. Date: Aug. 16, 2007

(54) Fluted filter apparatus

(75) Inventors: Robert M. Wydeven, Eagan, MN (US); Gene W. Brown, Franklin, TN (US); Steven J. Merritt, Kearney, NE (US)

Correspondence Address: REINHART BOERNER VAN DEUREN P.C., 2215 PERRYGREEN WAY, ROCKFORD, IL, 61107, US

(73) Assignee: Baldwin Filters, Inc., Kearney, NE (US)

(21) Appl. No.: 11/355,064

(22) Filed: Feb. 15, 2006

(51) Int. Cl. B01D 46/00

(52) U.S. Cl. 55/498

(57) ABSTRACT

A filter element and filter apparatus, and a method for fabricating a filter element, include a filter element having alternating layers of a face sheet material and a convoluted filter material, with the alternating layers forming substantially longitudinally oriented flutes that extend axially along, or past, a radially acting seal, into previously unused portions of the cavity of a filter housing. In some embodiments, structures such as struts extending partially across an outlet end of the filter element, or a rigid web formed by a layer of resin extending axially a potted length into some of the flutes from the outlet end resist axially oriented pressure forces on the alternating layers.

### FIELD OF THE INVENTION

This invention relates to fluid filters, and more particularly to filters having a housing adapted for receiving a filter element including a seal member for sealing a juncture between the filter housing and the filter element when the filter element is installed in filter housing.

### BACKGROUND OF THE INVENTION

As shown in FIG. 1, filter apparatuses 10 of the type used for filtering particulate matter from fluid sometimes include a filter housing 12 having an inlet 14 for receiving the fluid with entrained particulate matter, and an outlet 16 for delivering the filtered fluid to a device needing fluid that is free of particulate matter. For example, a filter may be provided at the air inlet of an engine or an air compressor to remove dust, water, or other particulate matter that could cause damage to the engine or compressor if it were not removed from the air entering the engine or compressor.

In such filters 10, the particulate matter is typically removed by a primary filter element 18 that is installed within the filter housing 12 in such a manner that the fluid must flow through the primary filter element 18, in traveling from the inlet 14 to the outlet 16 of the filter 10. The filter element 18 includes a filter pack 20 of porous filter material, which removes the particulate matter from the fluid. Over time, the filter pack 20 of the primary filter element 18 becomes plugged or coated with particulate matter, necessitating removal and replacement of the primary filter element 18, in order for the filter 10 to continue in its function of supplying particulate-free fluid at the outlet 16 of the filter 10.

In order to facilitate removal and replacement of the primary filter element 18, it is known to configure the filter housing 12 to include a generally tubular wall 24 thereof, and to provide a seal member 42, mounted on the primary filter element 18, for sealing the juncture between an inner surface 26 of the tubular wall 24 and the filter element 18, when the primary filter element 18 is inserted into the housing 12, so that the fluid cannot bypass the primary filter element 18 while flowing through the housing 12.

Such filter apparatuses also sometimes include a secondary filter 27, inserted into the housing 12 downstream from the primary element 18. The secondary filter 27 is used as a safety filter, in case the primary filter 18 should come apart in service. Where the direction of airflow through the primary filter 18 is downward, as shown in FIG. 1, the secondary filter 27 also provides a means for catching any particulate matter that might otherwise fall from the primary filter element 18 into the outlet 16 of the housing 12, when the primary filter element 18 is replaced. Typically the secondary filter element 27 is not replaced as frequently as the primary filter element 18.

In one commonly used prior filter apparatus 10, as shown in FIG. 1, the tubular wall 24 of the housing 12 is stepped to form first 28, second 30 and third 32 tubular sections of the housing 12, sequentially arranged along a longitudinal axis 34 of the filter housing 12, and having progressively decreasing cross sectional areas. The inner surface 26 of the filter housing 12 defines a cavity 36 extending along the axis 34, with the inlet 14 at one axial end of the cavity 36 and the outlet 16 at the opposite axial end of the cavity 36. The first tubular section 28 extends from the inlet 14. The third tubular section 32 is disposed adjacent the outlet 16, and the second tubular section 30 connects the first and second tubular sections 28, 32. U.S. Pat. No. 6,517,598 to Anderson, et al, illustrates a filter apparatus 10 of the type depicted in FIG. 1.

The secondary filter element 27 is inserted into the third tubular section 32, and seals against the inner surface 26 of the housing 12. The secondary filter 27 typically includes a filter material 29 attached to a rigid frame 31. The upstream side of the frame 31 is configured to function as a handle which can be grasped during insertion and removal the secondary filter 27. U.S. Pat. Nos. 6,517,598 to Anderson, et al, and 6,211,122, to Gieske, et al, disclose this type of secondary filter element. Where the housing has a large cross section, it has also sometimes been the practice in the past to include a specially formed handle on the frame 313 of secondary filter 27, with the handle extending some distance upstream, between the primary and secondary filter elements 18, 27, as illustrated in U.S. Pat. No. 6,235,195 to Tokar.

The primary filter element 18 includes the filter media pack 20, a mounting flange 40 attached to the inlet end of the media pack 20, and a seal support frame 44, which includes an annular axial extension thereof that projects axially from the outlet end of the media pack 20, for supporting the seal 42. The seal 42 is configured to seal radially against the inner surface 26 of the second tubular section 30 of the housing 12.

The seal support frame 44 typically includes webs 46 extending completely across the outlet end of the media pack 20. These webs 46 are provided to resist pressure forces acting on the media pack 20, which could cause the center of the media pack 20 to bow outward in a downstream direction. It has heretofore been believed, by those having skill in the art, that such webs 46 extending completely across the outlet face of the media pack 20 were particularly necessary in media packs formed by coiling layers of convoluted filter material to form a so-called “fluted filter,” in order to prevent the center of the filter media pack 20 from telescoping in a downstream direction under maximum rated inlet fluid pressures. U.S. Pat. Nos. 6,190,432 and 6,610,177 to Gieske, et al, disclose filter packs having seals attached to axially extending annular portions of a seal support frame.

As illustrated at ‘A’ in FIG. 1, having the seal 42 mounted on an axially extending annular extension of the seal support frame 44, together with the space occupied by the webs 46 at the outlet end of the filter pack 20, and the portions of the frame 31 of the secondary filter element 27 disposed between the primary and secondary filters 18, 27, undesirably consumes a significant portion of the volume in the cavity 36 of the housing 12 between the primary and secondary filters 18, 27. This is particularly true where the secondary filter element 27 includes a handle, as disclosed by Tokar.

It is desirable, therefore, to provide an improved filter element, and filter apparatus in a form which better utilizes the volume inside of the cavity of the filter housing, and particularly in a form which better utilizes the volume between the primary and secondary filter elements in a filter apparatus, of the type described above, which includes both a primary and a secondary filter element.

### BRIEF SUMMARY OF THE INVENTION

The invention provides an improved filter element and filter apparatus, through the use of a filter element having alternating layers of a face sheet material and a convoluted filter material, with the alternating layers forming substantially longitudinally oriented flutes that extend axially along, or past, a radially acting seal into previously unused portions of the cavity of a filter housing. In some forms of the invention, structures such as struts extending partially across an outlet end of the filter element, or a layer of resin extending axially a potted length into some of the flutes from the outlet end, are provided to resist axially oriented pressure forces on the alternating layers.

The invention may take the form of a filter element, a filter apparatus, or a method for forming or using a filter element, or a filter apparatus, according to the invention.

In one form of the invention, a filter element includes a media pack, a seal support ring, and a radially acting seal. The media pack defines a longitudinal axis of the filter element and includes a plurality of alternating layers of a face sheet material and a convoluted filter material, with the alternating layers forming substantially longitudinally oriented flutes for passage of a fluid through the filter element. The plurality of alternating layers define an outer periphery of the media pack extending axially from an inlet end of the media pack to an outlet end of the media pack. The seal support ring includes a body thereof that is disposed radially about and attached to the outer periphery of the media pack, adjacent the outlet end of the media pack, but not extending substantially axially beyond the outlet end of the media. The seal is attached to the seal support ring and axially spaced from the outlet end a distance such that the longitudinally oriented flutes of the filter pack extend axially along the seal. In some forms of the invention, the longitudinally oriented flutes of the filter element may extend axially beyond the seal.

The alternating layers of face sheet material and convoluted filter material, may be secured to one another with adhesive beads disposed on both sides of the layers of convoluted filter material, with the glue beads sized for securing the convoluted layers to the adjacent layers of face sheet material without blocking flow through the flutes.

The invention may also include a layer of resin extending axially a potted length into some of the flutes from the outlet end of the media pack. The layer of resin may also include at least a portion of the body of the seal support ring, and in some forms of the invention may include the whole seal support ring. The seal support ring may extend axially from the outlet end of the media pack a distance greater than the potted length.

In some forms of the invention, the seal support ring may include a plurality of through-holes therein, with the seal being molded onto the seal support ring in such a manner that portions of the seal extend through the through-holes and bond the seal and seal support ring to the media pack. The seal support ring may also include a plurality of struts extending partially across the outlet end of the filter element.

In another form of the invention, a filter apparatus includes a filter housing and a filter element disposed in the filter housing. The filter housing defines a longitudinal axis of the filter apparatus and has an inner surface defining a cavity extending along the axis and having an inlet at one axial end of the cavity and an outlet at an opposite axial end of the cavity. The inner surface of the filter housing includes at least first and second sections thereof, with the first section extending axially from the inlet and defining a first substantially radially inwardly facing surface, and the second section being axially disposed between the first section and the outlet. The second section protrudes radially inward beyond the first section and defines a second substantially radially inward facing surface.

The filter element defines an outer peripheral surface thereof extending axially from an inlet end to an outlet end of the filter element, with the outer peripheral surface of the filter element including an outlet end portion thereof disposed at least partially within the second section of the housing. The filter element includes a media pack having a plurality of alternating layers of a face sheet material and a convoluted filter material, with the alternating layers forming substantially longitudinally oriented flutes extending to the outlet end of the filter element for passage of a fluid through the filter element. The filter element also includes a radially acting seal, attached to the outlet end portion of the outer periphery of the filter element. The seal is axially spaced from the outlet end of the filter element a distance such that the longitudinally oriented flutes of the filter pack extend axially along the seal, and at least partially along the second substantially radially inwardly facing surface of the housing, when the seal is acting against one of the first or second substantially radially inwardly facing surfaces.

The longitudinally oriented flutes of the filter element may extend axially beyond the seal, and in some forms of the invention may extend substantially completely through the second section of the housing.

The inner surface of the filter housing may further include a third section thereof disposed axially between the outlet and the second section of the inner surface of the filter housing, with the third section defining a third substantially radially inwardly facing surface. The outlet end portion of the filter element may be disposed at least partially within the third substantially inwardly facing surface, and the radially acting seal may be attached to the outlet end portion of the outer periphery of the filter element and axially spaced from the outlet end of the filter element a distance such that the longitudinally oriented flutes of the filter pack extend axially along the seal and at least partially along the third substantially radially inwardly facing surface when the seal is acting against one of the first or second substantially radially inwardly facing surfaces of the housing.

Other aspects, objectives and advantages of the invention will be apparent from the following detailed description and the accompanying drawings.

### BRIEF DESCRIPTION OF THE DRAWINGS

FIG. 1 a cross section of a prior filter apparatus having a primary and a secondary filter element mounted in a filter housing having a stepped wall.

FIG. 2 is a cross section of an exemplary embodiment of a filter apparatus, according to the invention.

FIG. 3 is a perspective view showing details of forming an exemplary embodiment of a media pack for a filter element, according to the invention, including the placement of adhesive beads on both sides of a corrugated sheet of filter media, as the media pack is being formed.

FIG. 4 is an enlarged partial cross sectional view of a portion of the exemplary embodiment of the filter apparatus shown in FIG. 2, showing a first exemplary embodiment of a seal and seal support ring, according to the invention.

FIGS. 5A and 5B are enlarged partial cross sections of the same portion of the exemplary filter apparatus shown in FIG. 4, showing two alternate exemplary embodiments of filter elements, in accordance with the invention.

FIG. 6 is a perspective view showing details of a seal and seal support ring of the filter element shown in FIGS. 2 and 4.

FIG. 7A is an enlarged cross section of the same portion of the exemplary filter apparatus shown in FIG. 4, showing an alternate exemplary embodiment of a seal and seal support ring, in accordance with the invention.

FIG. 7B is a perspective drawing showing details of the seal support ring of the embodiment shown in FIG. 7A.

FIGS. 8 and 9 show alternate embodiments of a filter element, according to the invention, including a rigid web formed internally to the outlet end of the filter element by a layer of resin.

FIG. 10 shows a mold used for forming a rigid web of the type shown in FIGS. 8 and 9, and attaching a seal to a filter element including a layer of resin forming the rigid web.

FIG. 11 is a perspective view of an oblong, or race-track shaped filter element, including a seal support ring of the type shown in FIGS. 2, 4, and 6.

FIG. 12 is a perspective view of an alternate embodiment of an oblong, or race-track shaped filter element, according to the invention, including a seal support ring of the type shown in FIGS. 7A and 7B.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

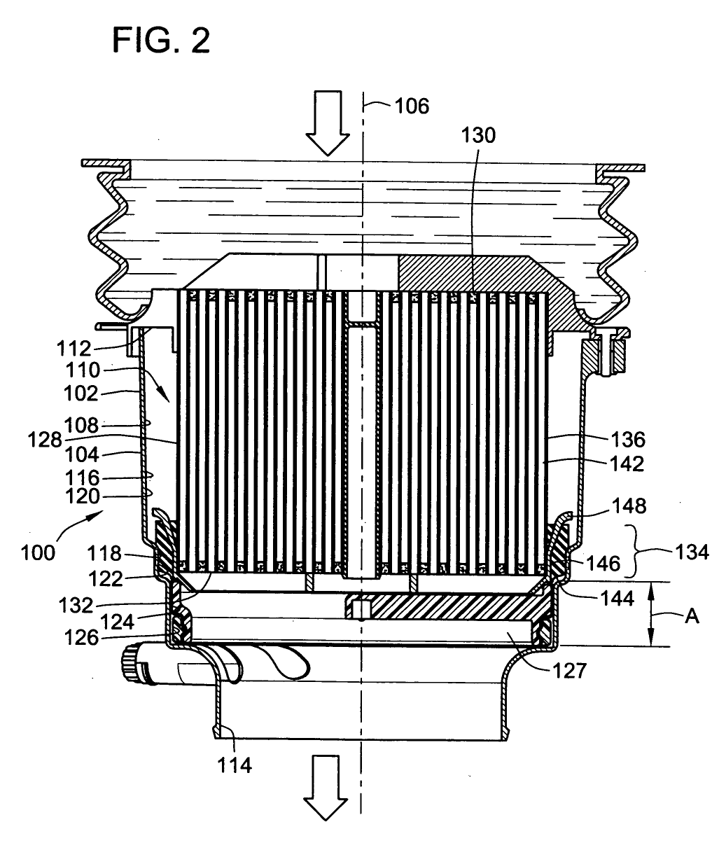

FIG. 2 shows a first exemplary embodiment of the invention in the form of a fluid filter apparatus 100 including a filter housing 102 and a filter element 104 disposed in the filter housing 102. The term fluid as used herein is intended to include fluids in either liquid or gaseous forms. The exemplary embodiments shown herein specifically illustrate an air filter of the type used for filtering intake air for engines and air compressors.

The filter housing 102 defines a longitudinal axis 106 of the filter apparatus 100 and has an inner surface 108 defining a cavity 110 extending along the axis 106 and having an inlet 112 at one axial end of the cavity 110, and an outlet 114 at an opposite axial end of the cavity 110. The inner surface 108 of the filter housing 102 includes at least first 116 and second 118 sections thereof, with the first section 116 extending axially from the inlet 112 and defining a first substantially radially inwardly facing surface 120, and the second section 118 being axially disposed between the first section 116 and the outlet 114. The second section 118 protrudes radially inward beyond the first section 116 and defines a second substantially radially inward facing surface 122.

The inner surface 108 of the filter housing 102 further includes a third section 124 thereof disposed axially between the outlet 114 and the second section 118 of the inner surface 108 of the filter housing 102, with the third section 124 defining a third substantially radially inwardly facing surface 126. A secondary filter 127 is installed within the third section 124 of the housing 102.

The primary filter element 104 defines an outer peripheral surface 128 thereof extending axially from an inlet end 130 to an outlet end 132 of the filter element 104, with the outer peripheral surface 128 of the filter element 104 including an outlet end portion 134 thereof disposed at least partially within the second section 118 of the housing 102.

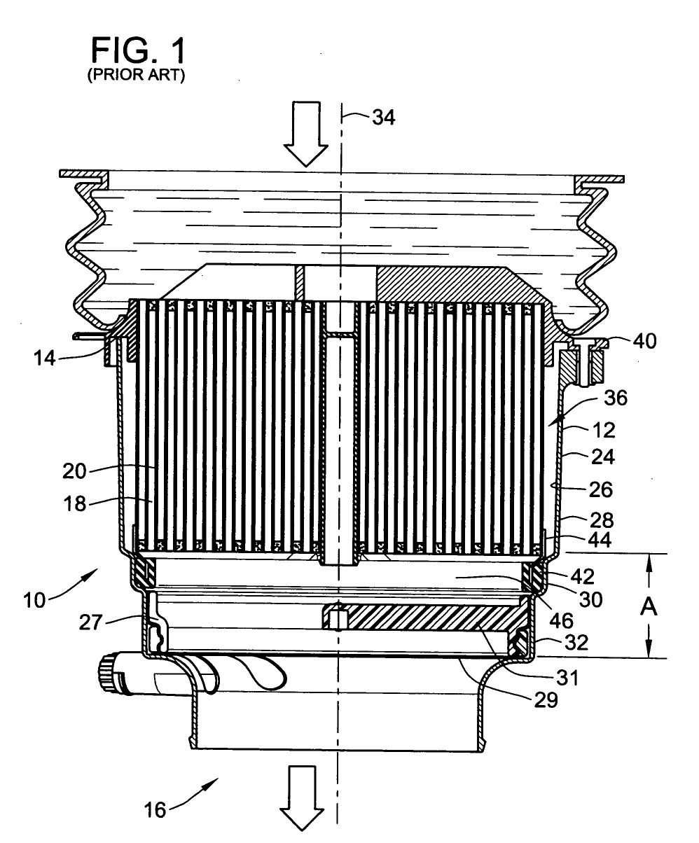

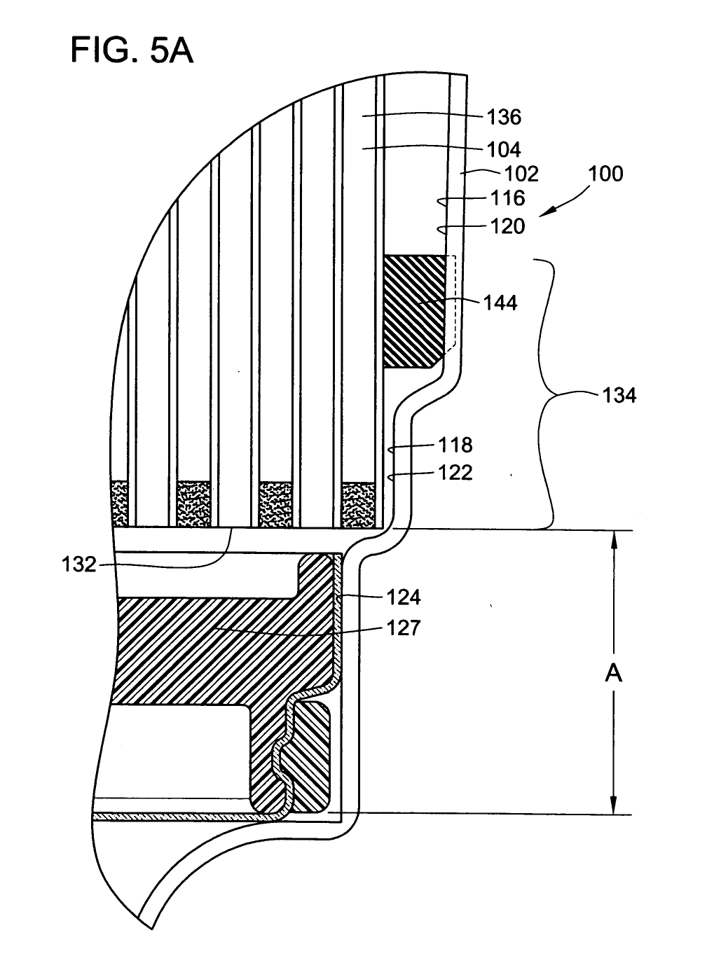

In the exemplary embodiment, the outlet end portion 134 of the filter element 104 extends substantially into the second section 120 of the housing 102, such that the filter element 104 is longer, and slightly smaller in cross-section, as compared to the filter element 20 of the prior filter apparatus 10 shown in FIG. 1. As shown in FIG. 5B, and described in more detail below, in other embodiments of the invention, the outlet end portion 134 of the filter element 104 can extend at least partially into the third section 124 of the housing 102, with the length of the filter element 104 being somewhat longer and the cross section of the filter element 104 being somewhat smaller than the exemplary embodiment shown in FIG. 2.

Through judicious selection of the length and cross section of the filter element 104, the invention allows the space inside of the cavity 110 to be used more effectively than in the prior filter apparatus 10 shown in FIG. 1. The resultant volume of the filter element 104, and its filtering capacity, can also be increased, as compared to prior filter elements having seal support frames extending axially beyond the end of the media pack of the filter element, through judicious selection of the dimensions of a filter element 104 according to the invention.

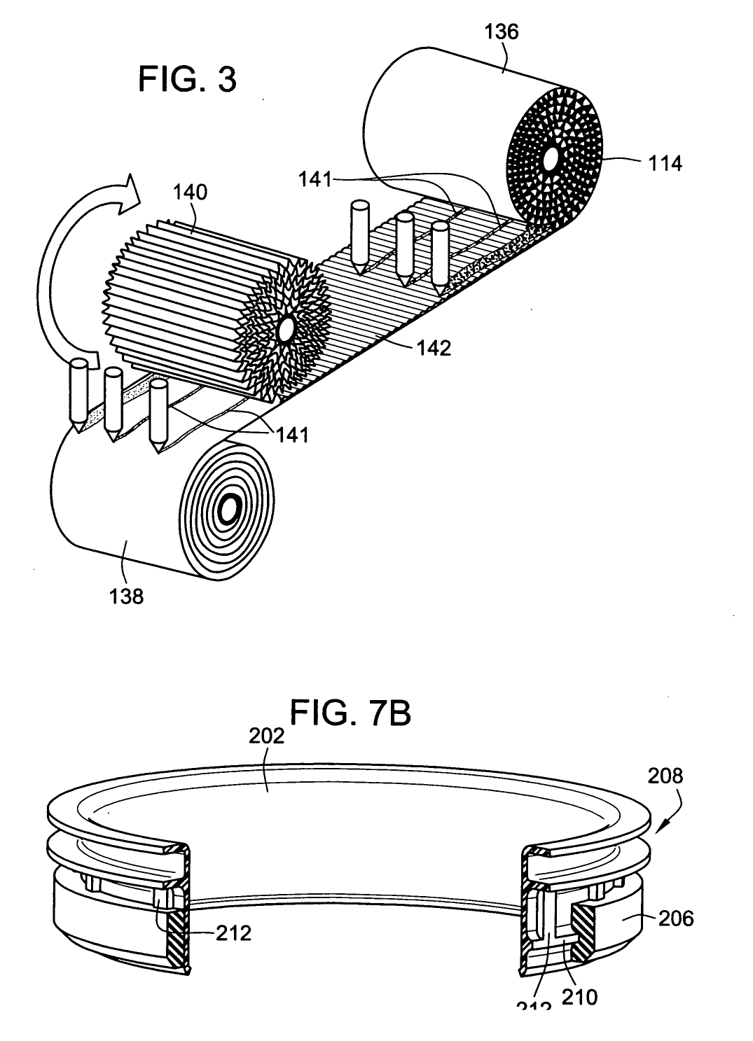

The filter element 104 includes a media pack 136. As illustrated in FIG. 3, the media pack 136 includes a plurality of coiled alternating layers of a face sheet material 138 and a convoluted filter material 140. The alternating layers form substantially longitudinally oriented flutes 142 extending to the outlet end 114 of the filter element 104 for passage of a fluid through the filter element 104.

In some embodiments of the invention, as illustrated in FIG. 3, alternating layers of the face sheet material 138 and the convoluted filter material 140 are secured to one another with adhesive beads 141 disposed on both sides of the layers of convoluted filter material 140, with the adhesive beads 141 being sized for securing the convoluted layers 140 to the adjacent layers of face sheet material 138 without blocking flow through the flutes 142. These adhesive beads 141 serve to more securely fasten adjacent alternating layers of the media pack 136 together, in a manner that provides additional resistance to telescoping of the alternating layers by axial forces on the media pack 136 resulting from fluid pressure.

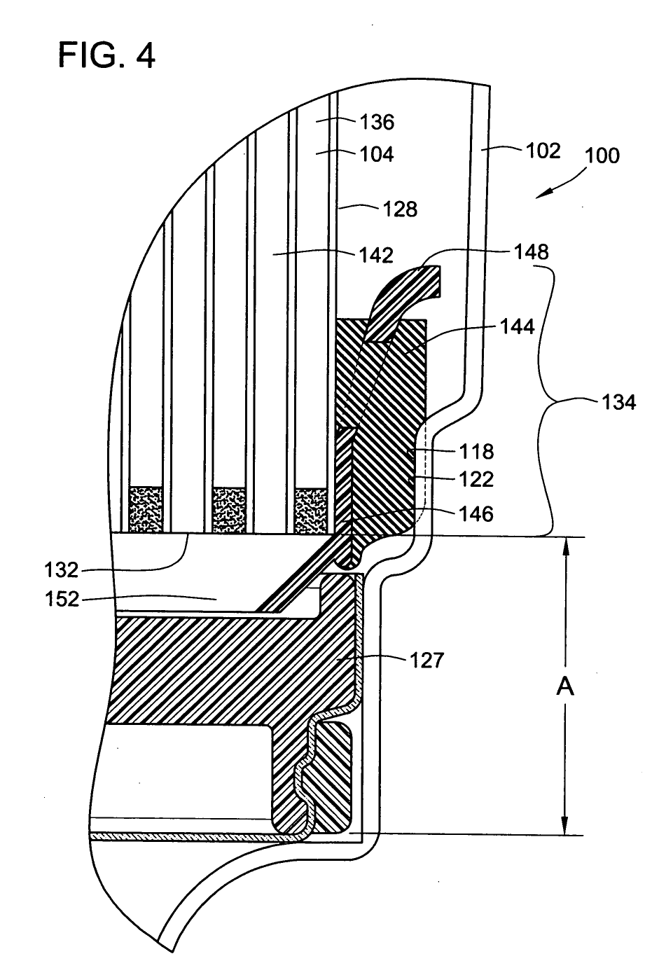

As shown in FIGS. 2 and 4, the filter element 104 also includes a radially acting seal 144, attached to the outlet end portion 134 of the outer periphery 128 of the filter element 104. As used herein, the term radially acting seal is intended to include seal configurations of various forms and materials that are compressible, deflectable, or otherwise configured to provide a radially acting sealing force against the inner surface 126 of the housing 102, when the filter element 104 is installed in the housing 102.

In the exemplary embodiment of the filter apparatus 100 shown in FIG. 2, the seal 144 is axially spaced from the outlet end 132 of the filter element 104 a distance such that the longitudinally oriented flutes 142 of the filter pack 104 extend axially along the seal 144, and at least partially along the second substantially radially inwardly facing surface 122 of the housing 102, when the seal 144 is acting against the second substantially radially inwardly facing surface 122. As shown in FIG. 5A, in other embodiments of the invention, the seal 144 may be positioned farther from the outlet end 132 of the filter element 104 and act radially against the first substantially radially inward oriented surface 120, so that the cross sectional area of the media pack 136 can be increased to more closely match the second substantially radially inward facing surface 122 of the second section 118 of the housing 102.

As shown in FIG. 5B, in alternate embodiments of the invention where the filter element 104 is disposed at least partially within the third section 124 of the housing 102, the radially acting seal 144 may be attached to the outlet end portion 134 of the outer periphery 128 of the filter element 104 and axially spaced from the outlet end 132 of the filter element 104 a distance such that the longitudinally oriented flutes 142 of the media pack 136 extend axially along the seal 144 and at least partially along the third substantially radially inwardly facing surface 126 when the seal 144 is acting against one of the first or second substantially radially inwardly facing surfaces 120, 122 of the housing 102.

In any of the embodiments shown in FIGS. 2, 4, and 5A-5B, it will be seen that the axial distance ‘A’ between the primary and secondary filter elements 104, 127, in a filter apparatus according to the invention, is shorter than in the prior filter apparatus 10 shown in FIG. 1, and more completely filled with filter material. Reducing the distance ‘A’ between the primary and secondary filter elements thus leads to improved utilization of the volume of the cavity 110 of the housing 102 in a filter apparatus according to the invention.

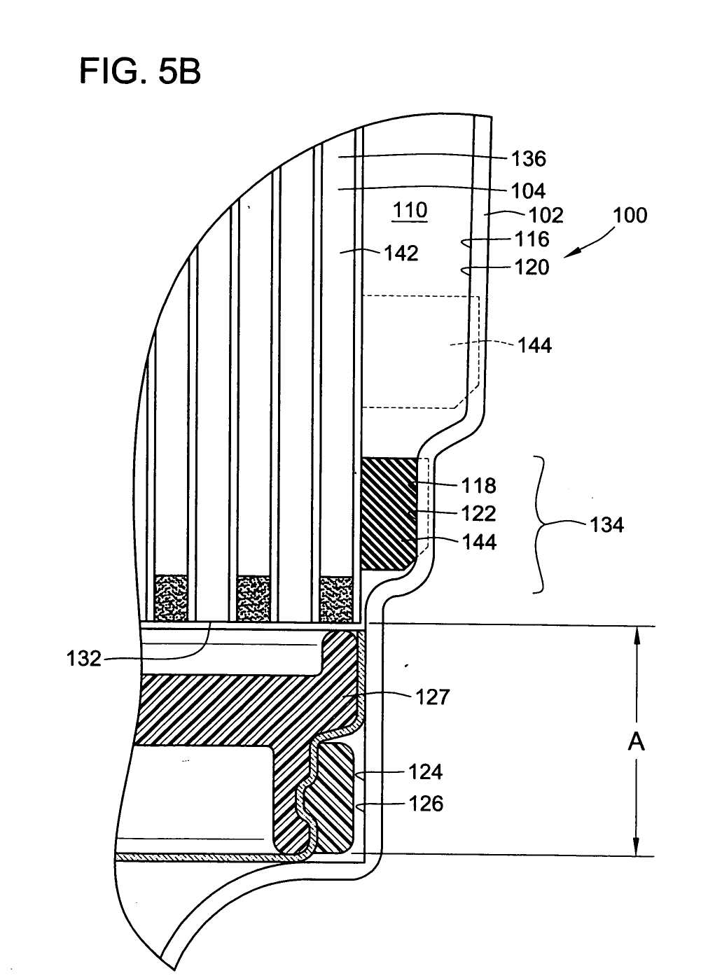

The outlet end portion of a filter element, according to the invention may take a number of forms. In the exemplary embodiment of the filter element 104 shown in FIGS. 2, 4 and 6, for example, the seal 144 is attached to the body 146 of a seal support ring 148, which is in turn attached to the outer peripheral surface 128 of the media pack 136. Specifically, the seal support ring 148 of the filter element 104 of FIGS. 2, 4 and 6, is disposed about and attached to the media pack 136, and the seal 144 is attached to the seal support ring 148. As best seen in FIGS. 4 and 6, the seal support ring 148 includes a plurality of through holes 150 therein, and the seal 144 is molded onto the seal support ring 148, with portions of the seal 144 extending through the through-holes 150 and bonding both the seal 144 and the seal support ring 148 to the media pack 136. It is contemplated that such a seal 144 might be molded from a polyurethane foam material, for example.

The seal support ring 148 of the embodiment shown in FIGS. 2, 4 and 6 also includes a plurality of struts 152 extending radially inward from the body 146 of the seal support ring 148, partially across the outlet end 132 of the media pack 136 of the filter element 104. These struts 152 provide resistance to fluid forces acting on the element 104, to preclude telescoping of the alternating layers in the media pack 136, in a manner that is more compact than the approach taken in the prior filter apparatus shown in FIG. 1. The struts 152 may be curved, and/or have their radial inner ends connected, in various embodiments according to the invention.

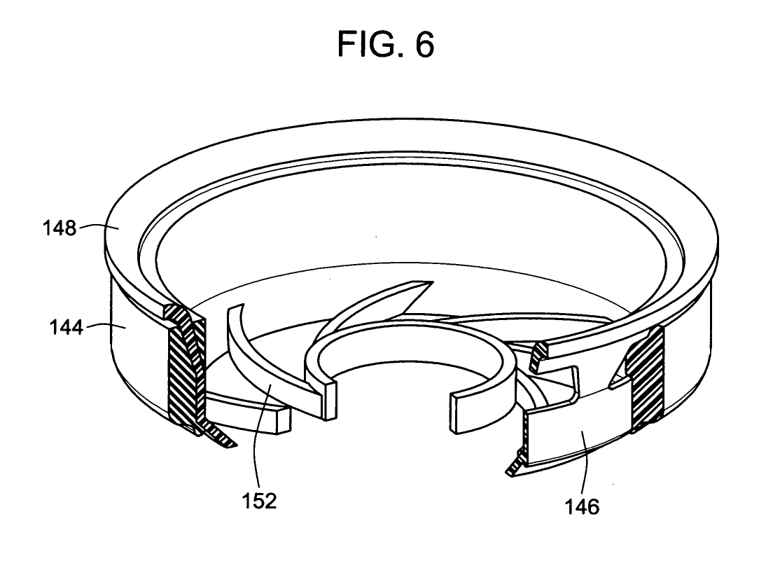

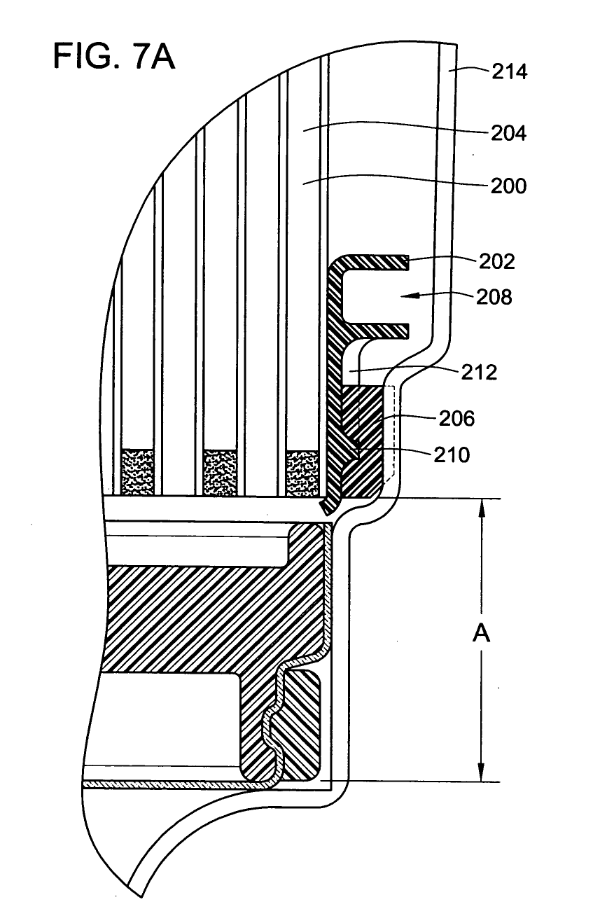

FIGS. 7A and 7B show an alternate embodiment of a seal support ring 202 of an alternate embodiment of a filter element 200, according to the invention. As shown in FIG. 7A, the seal support ring 202 is attached to a media pack 204, with a press fit or an adhesive, and a radially acting seal 206 is attached to the seal support ring 202 but not directly to the media pack 204. The seal support ring 202 includes a channel-shaped annular section 208, a radially extending annular flange 210, and a plurality of circumferentially spaced, axially-extending ribs 212, to provide rigidity in the seal support ring 202, and to support the seal 206 during installation and operation of the filter element 200 in a housing 214.

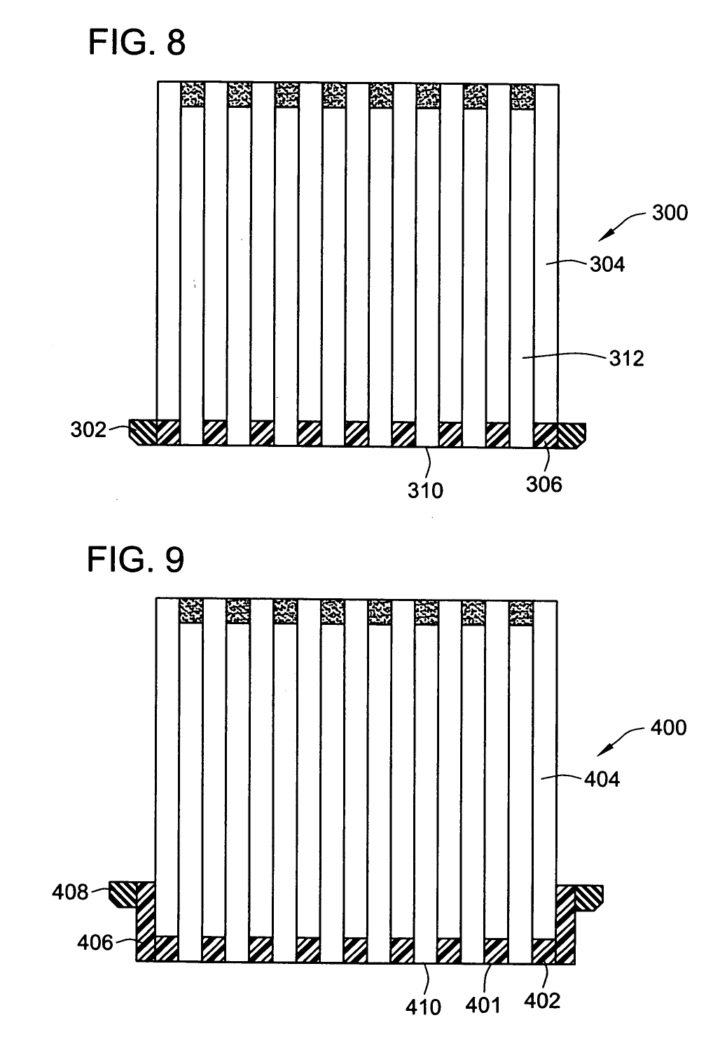

FIGS. 8 and 9 show alternate embodiments of filter elements 300, 400, according to the invention, in which the outlet end portion of the element includes a layer of resin extending axially a potted length into some of the flutes from the outlet end of the filter element, for providing resistance to telescoping of the alternating layers of the media pack, without having to resort to the use of struts or webs extending across the outlet end of the filter element. A wide range of resins can be used in practicing the invention, including, but not limited to: thermoset and thermoplastic polymers, urethanes, epoxies, and ceramic filled polymers.

It is contemplated that such a layer of resin might be formed in accordance with the method disclosed in commonly assigned U.S. Pat. No. 6,743,317, to Wydeven, which is incorporated herein by reference. In addition to the method of Wydeven, the present invention contemplates attaching or forming the seal as part of the process of forming the layer of resin, in the manner taught by Wydeven.

In the filter element 300 of FIG. 8, a radially acting seal 302 is attached to the outer periphery of a media pack 304 which includes a layer 306 of resin at the outlet end 310 of the filter element 300. The seal 302 is axially spaced from the outlet end 10 in such a manner that the longitudinally oriented flutes 312 of the media pack 304 extend at least along the seal 302, as shown in FIG. 8, and alternatively extend axially beyond the seal 302 to form an end configuration of the type illustrated in FIGS. 5A and 5B.

The layer 306 of cured resin, in alternating closed ends of the flutes 312 tends to partially impregnate the corrugated filter material and face sheets that form the flutes 312, and forms a rigid web within the outlet end 310 of the filter element 300. This rigid web provides radial support for the outlet end 310 to react radially and axially directed forces that are imposed on the media pack 304 by the radially acting seal 302, during installation and operation of the filter element 300. The rigid web also resists telescoping of the alternating layers of the media pack 304 under axially directed fluid pressure, without the need, in some embodiments, for additional webs, struts or ribs extending across the outlet end 310 external to the media pack 304. Where such external structures can be eliminated or reduced in size, through use of an internally located rigid web formed by the layer 306 of resin, the distance ‘A’ between a primary and a secondary filter element can be reduced and the media pack extended so that the filtering capacity of the filter element 300 is increased.

In the filter element 400 of FIG. 9, in addition to forming a rigid web 402 within the outlet end of the media pack 404, a layer 401 of cured resin extends axially along the outer periphery of the media pack 404 to at least partially form a seal support ring 406. A seal 408 is attached to the seal support ring 406. Having the layer 401 of resin at least partially form the seal support ring 406 integrally joins the seal support ring 406 to the rigid web 402 of cured resin within the outlet end 408 of the media pack 402, so that the outlet end portion of the filter element 400 can be made more structurally robust than the embodiment of filter element 300 shown in FIG. 8.

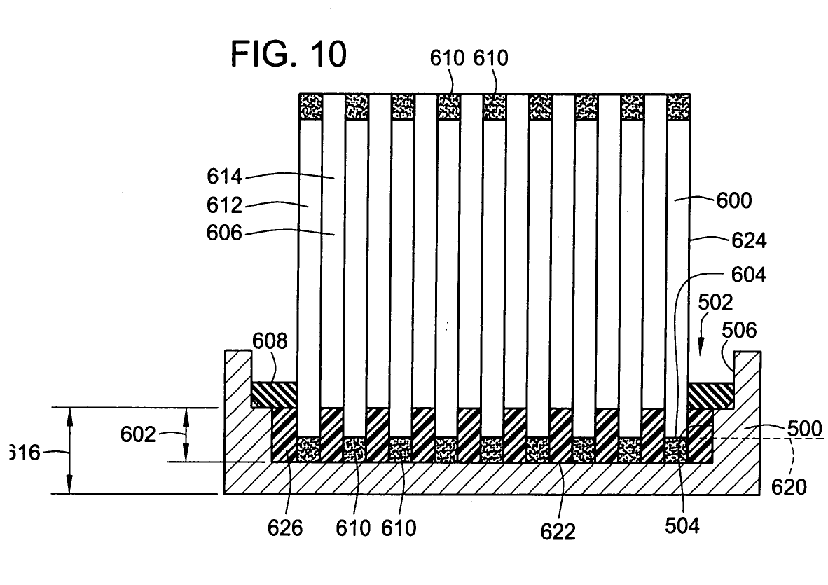

FIG. 10 illustrates a mold 500 which can be used for forming a filter element 600, according to the invention, having a resin layer 602 at the outlet 604 of a filter media pack 606 and a seal 608 attached to the resin layer 602. To perform such a process for manufacturing a filter element, in accordance with aspects of the invention, the filter media pack 606 is formed from a flat face sheet of filter material and a convoluted sheet of filter material, positioned one on top of the other in alternating layers to form longitudinally extending flutes 612, 614 in the media pack 606. The flat sheet and the convoluted sheet are substantially of the same length and width and are bonded to each other by using a sealing composition in a pre-determined, relatively narrow area on or near opposing sides such that the sealing composition forms plugs 610 on either side, which define confined flutes 612 between the convoluted sheet and the face sheet.

A predetermined length of the filter media is assembled such that a series of flutes 612 which are plugged on both sides, and a series of unplugged flutes 614, are formed. The filter pack 606 is vertically positioned so that the plugs 610 on one side of the confined flutes 612 face downward, as shown in FIG. 10, into a receptacle 502 of the mold 500, which contains an amount of sealant resin having a sufficient height for filling the unplugged flutes 614 to a potted length 616 higher than the top edges of the downwardly facing plugs 610 in the confined flutes 612.

The lower end of the media pack 606 is inserted into the receptacle 502 to a sufficient depth to fill a portion of each of the unplugged flutes 614 to the potted length 616. Without removing the media pack 606 from the receptacle 502, the seal 602 is attached to the layer 602 of sealant resin, and then the media pack 606 is cut, as indicated at dashed line 620 so that the cut is above the downwardly facing plug 610 for each of the confined flutes 614 but below the top surface of the cured sealant which filled a portion of each of the unplugged flutes 612, thereby forming the completed filter element 600. The filter completed filter element 600 includes a series of flutes 612 which are plugged on only one side, a series of flutes 614 plugged on only the opposite side, and a seal 608, with the layer of resin 616 in the flutes 614 forming a structural web at one end 622.

The seal 608 can be attached to the layer of resin by a number of methods, either prior to, or after the media pack 606 is removed from the mold 500, and prior to, or after the lower end is cut off of the media pack 606. For example, a pre-formed seal 608 may be attached with an adhesive, before or after the media pack 606 is removed from the mold. The seal 608 may alternatively be formed in-situ onto the media pack 606.

Where it is desired to form the seal 608 in-situ, the receptacle 502 in the mold 500 defines a first cavity 504 thereof, for containing the resin sealant, and a second cavity 506 thereof, for receiving a seal material in an uncured state. The method further includes forming the seal 608 by placing a sufficient volume of the seal material in the uncured state in to the second cavity 506, and allowing the seal material to cure, before removing the filter media pack 606 with attached seal 608 from the receptacle 502. This method results in the seal 608 being structurally attached directly to a portion of the layer of resin 616 extending around the outer periphery 624 to form a seal support ring 626, as shown in FIG. 10. In other embodiments of the invention, where a first receptacle in a mold fits so tightly around the outer periphery of a filter media pack that no seal support ring is formed, a method according to the invention, results in the seal being indirectly connected to the resin layer through the outer layers of the media pack, which are partially impregnated with the resin during the process of fabricating the resin layer.

Where it is desired to have the layer of resin 602 include a seal support ring 626 that extends axially beyond the potted length 616, additional sealant resin is added into the receptacle of a mold, essentially as described above, prior to attaching or forming the seal, to form an elongated seal support ring extending from the layer of sealant and having an axial length greater than the filled portion of each of the unplugged flutes 614. The seal 608 is attached to, or formed in-situ upon, the seal support ring 626 of the layer 602 of sealant. Where it is desired to have a seal attached to a radially outer surface of a seal support ring, extended or otherwise, a two piece mold, or a multi-step process may be utilized for forming the seal.

In some embodiments of the invention including a resin layer, the methods described above may also include securing alternating the layers of face sheet material and convoluted filter material to one another with adhesive beads disposed on both sides of the layers of convoluted filter material, as described above in relation to FIG. 3, with the adhesive beads being sized for securing the convoluted layers to the adjacent layers of face sheet material without blocking flow through the flutes. The adhesive beads work in conjunction with the rigid resin layer to more securely fasten adjacent alternating layers of the media pack together in a manner that provides additional resistance to telescoping of the alternating layers by axial forces on the media pack resulting from fluid pressure.

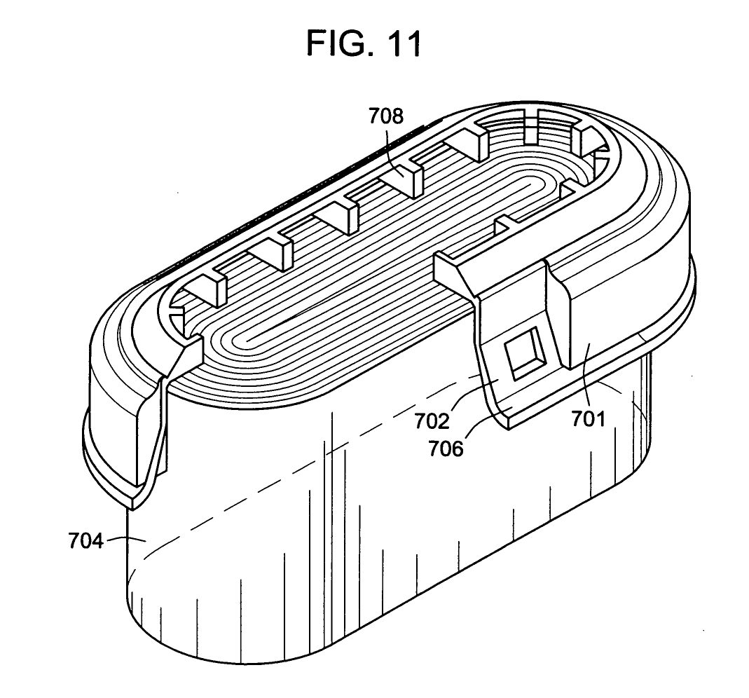

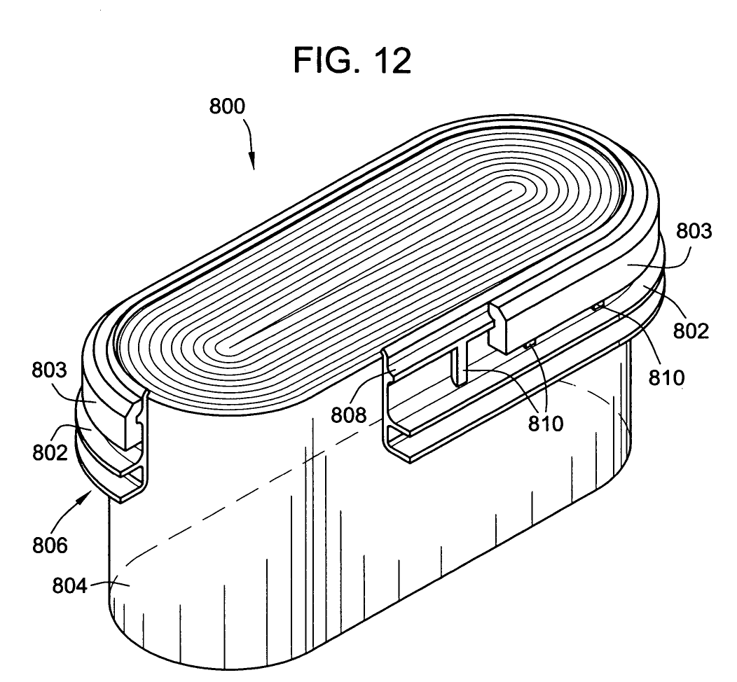

Those having skill in the art will recognize that, although the preceding disclosure has focused primarily on filter apparatuses and filter elements having generally right-circular cylindrical shapes, the invention may also be practiced in filter apparatuses and with filter elements having other cross sectional shapes. For example, FIGS. 11 and 12 illustrate alternate exemplary embodiments of the invention in the form of filter elements having oblong, or race-track shaped cross sections.

In the exemplary embodiment of the filter element 700 shown in FIG. 11, a seal 701 is attached to the body of a seal support ring 702, which is in turn attached to the outer peripheral surface of a race-track shaped media pack 704. The seal support ring 702 includes a skirt-like outwardly extending flange 706, which provides significant support and rigidity to the seal support ring 702, particularly in the straight-sided wall portions of the seal support ring 702. Those having skill in the art will recognize that the outwardly extending flange 706 of the seal ring 702 allows various embodiments of the invention to withstand forces incident in service, without having to resort to the ribs extending completely across the axial end of the media pack 704 that were required in prior filter elements. The embodiment shown in FIG. 11 does include a plurality of struts 708 extending radially inward from the body of the seal support ring 702, partially across the outlet end of the media pack 704 of the filter element 700. These struts 708 provide resistance to fluid forces acting on the element 700, to preclude telescoping of the alternating layers of the media pack 704, in a manner that is more compact than the approach taken in the prior filter apparatus shown in FIG. 1. The struts 708 may be curved, and/or have their radial inner ends connected, in various embodiments according to the invention. In some embodiments of the invention, however, the outwardly extending flange 706 provides sufficient stiffness under operating conditions that the struts 708 may be partially or totally eliminated from the seal support ring 702.

In the embodiment of the filter element 800, shown in FIG. 12, a seal support ring 802 is attached to a race-track shaped media pack 804, with a press fit, or an adhesive, and a radially acting seal 803 is attached to the seal support ring 802 but not directly to the media pack 804. The seal support ring 802 includes a channel-shaped annular section 806, a radially extending annular flange to 808, and a plurality of circumferentially spaced, axially-extending ribs 810, to provide rigidity in the seal support ring 802, and to support the seal 803 during installation and operation of the filter element 800 in a housing. As was the case with the embodiment of the filter element 700 shown in FIG. 11, the channel-shaped annular section 806, the radially extending annular flange 808, and the porality of circumferentially spaced, axially-extending ribs 810 provide sufficient rigidity in some embodiments of the invention, that the support webs and frames extending across the outlet of the filter element which were required in prior filter elements can be eliminated in a filter element according to the invention.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter apparatus comprising:
a filter housing and a filter element disposed in the filter housing;
the filter housing defining a longitudinal axis of the filter apparatus and having an inner surface defining a cavity extending along the axis and having a housing inlet at one axial end of the cavity and a housing outlet at an opposite axial end of the cavity;
the inner surface of the filter housing including at least first and second sections thereof, with the first section extending axially from the inlet and defining a first substantially radially inwardly facing surface, and the second section being axially disposed between the first section and the outlet, the second section protruding radially inward beyond the first section and defining a second substantially radially inward facing surface;
the filter element defining an outer peripheral surface thereof extending axially from an inlet end to an outlet end of the filter element, and an outlet end portion of the filter element disposed at least partially within the second section;
the filter element including a media pack having a plurality of alternating layers of a face sheet material and a convoluted filter material, with the alternating layers forming substantially longitudinally oriented flutes extending to the outlet end of the filter element for passage of a fluid through the filter element;
the filter element also including a radially acting seal attached to the outlet end portion of the filter element and axially spaced from the outlet end of the filter element a distance such that the longitudinally oriented flutes of the filter pack extend axially along the seal and at least partially along the second substantially radially inwardly facing surface of the housing when the seal is acting against one of the first or second substantially radially inwardly facing surfaces.

2. The filter apparatus of claim 1, wherein the seal is axially spaced from the outlet end of the media pack such that the longitudinally oriented flutes of the filter element extend axially beyond the seal between the seal and the outlet of the media pack.

3. The filter apparatus of claim 1, wherein the seal acts against the first substantially radially inwardly facing surface of the housing.

4. The filter apparatus of claim 1, wherein the second substantially radially inwardly facing surface of the housing defines an axial length of the second section of the inner wall of the housing, and the outlet end portion extends substantially completely along the axial length of the second section of the housing.

5. The filter element of claim 4, wherein the seal acts against the first substantially radially inwardly facing surface.

6. The filter apparatus of claim 1, wherein:
the inner surface of the filter housing further includes a third section thereof disposed axially between the housing outlet and the second section of the inner surface of the filter housing, with the third section defining a third substantially radially inwardly facing surface;
the outlet end portion of the filter element is disposed at least partially within the third substantially inwardly facing surface; and
the radially compressible seal is attached to the outlet end portion of the filter element and is axially spaced from the outlet end of the filter element a distance such that the longitudinally oriented flutes of the filter pack extend axially along the seal and at least partially along the third substantially radially inwardly facing surface when the seal is acting against one of the first or second substantially radially inwardly facing surfaces.

7. The filter apparatus of claim 6, wherein the seal of the filter element acts against the first substantially radially inwardly facing surface of the housing.

8. The filter apparatus of claim 7, wherein the third section of the inner wall of the housing defines an axial length thereof, and the filter apparatus further comprises a secondary filter element disposed in the third section and having an axial length of the secondary filter that does not extend axially beyond the axial length of the third section of the inner wall of the housing.

9. The filter apparatus of claim 1, wherein the alternating layers of a face sheet material and a convoluted filter material, are secured to one another with adhesive beads disposed on both sides of the layers of convoluted filter material, with the glue beads sized for securing the convoluted layers to the adjacent layers of face sheet material without blocking flow through the flutes.

10. The filter apparatus of claim 1, wherein the outlet portion of the filter element includes a layer of resin extending axially a potted length into some of the flutes from the outlet end of the filter element.

11. The filter apparatus of claim 10, wherein the layer of resin also includes a ring thereof forming part of the outlet end portion of the filter element, and the seal is attached to the ring of the layer of resin.

12. The filter apparatus of claim 1, wherein the outlet end portion of the filter element includes a seal support ring disposed about and attached to the media pack, and the seal is attached to the seal support ring.

13. The filter apparatus of claim 12, wherein the outlet end portion of the filter element includes a layer of resin extending axially a potted length into some of the flutes from the outlet end of the filter element.

14. The filter apparatus of claim 13, wherein the layer of resin also includes the seal support ring.

15. The filter apparatus of claim 14, wherein the support ring extends axially from the outlet end of the filter element a distance greater than the potted length.

16. The filter apparatus of claim 12, wherein:
the seal support ring includes a plurality of through holes therein; and
the seal is molded onto the seal support ring with portions of the seal extending through the through holes and bonding the seal and seal support ring to the media pack.

17. The filter apparatus of claim 12, wherein the seal support ring includes a plurality of struts extending partially across the outlet end of the filter element.

18. A filter element, comprising a media pack, a seal support ring, and a radially acting seal;
the media pack defining a longitudinal axis of the filter element and having a plurality of alternating layers of a face sheet material and a convoluted filter material, with the alternating layers forming substantially longitudinally oriented flutes for passage of a fluid through the filter element, the plurality of alternating layers defining an outer periphery of the media pack extending axially from an inlet end of the media pack to an outlet end of the media pack;
the seal support ring including a body thereof disposed radially about and attached to the outer periphery of the media pack adjacent the outlet end of the media pack, but not extending substantially axially beyond the outlet end of the media; and
the seal being attached to the seal support ring and axially spaced from the outlet end a distance such that the longitudinally oriented flutes of the filter pack extend axially along the seal.

19. The filter element of claim 18, wherein the seal is axially spaced from the outlet end of the media pack such that the longitudinally oriented flutes of the filter element extend axially beyond the seal between the seal and the outlet of the media pack.

20. The filter element of claim 18, wherein the alternating layers of a face sheet material and a convoluted filter material, are secured to one another with adhesive beads disposed on both sides of the layers of convoluted filter material, with the glue beads sized for securing the convoluted layers to the adjacent layers of face sheet material without blocking flow through the flutes.

21. The filter element of claim 18, further comprising a layer of resin extending axially a potted length into some of the flutes from the outlet end of the media pack.

22. The filter element of claim 21, wherein the layer of resin also includes at least a portion of the body of the seal support element.

23. The filter element of claim 18, wherein the layer of resin also includes the seal support ring.

24. The filter element of claim 23, wherein the support ring extends axially from the outlet end of the media pack a distance greater than the potted length.

25. The filter element of claim 18, wherein:
the seal support ring includes a plurality of through holes therein; and
the seal is molded onto the seal support ring with portions of the seal extending through the through holes and bonding the seal and seal support ring to the media pack.

26. The filter element of claim 25, wherein the seal support ring includes a plurality of struts extending partially across the outlet end of the filter element.

27. A process for manufacturing a filter element comprising:
providing filter media comprising a flat face sheet of filter material and a convoluted sheet of filter material, positioned one on top of the other in alternating layers, with the flat sheet and the convoluted sheet substantially of the same length and width and bonded to each other by a sealing composition in a predetermined, relatively narrow area on or near opposing sides such that the sealing composition forms plugs on either side which define confined flutes between the convoluted sheet and the face sheet;
assembling a predetermined length of the filter media such that a series of flutes which are plugged on both sides and a series of unplugged flutes are formed;
vertically positioning the predetermined length of filter media so that the plugs on one side of the confined flutes face downward;
providing a receptacle containing an amount of resin having a sufficient height for filling the unplugged flutes to a point higher than the downwardly facing plug for each of the confined flutes;
inserting the lower end of the downward facing filter media into the receptacle to a sufficient depth so that the resin fills a portion of each of the unplugged flutes to a point higher than the downwardly facing plug for each of the confined flutes;
without removing the filter media from the receptacle, attaching a seal to the layer of resin; and then
cutting the filter media so that the cut is above the downwardly facing plug for each of the confined flutes but below the top surface of the cured resin which filled a portion of each of the unplugged flutes thereby forming a filter element having a series of flutes which are plugged on only one side and a series of flutes plugged on only the opposite side.

28. The method of claim 27, wherein the receptacle defines a first cavity thereof for containing the resin, and a second cavity thereof for receiving a compressible seal material in an uncured state, and the method further comprises forming the seal by placing a sufficient volume of the compressible seal material in the uncured state in to the second cavity, and allowing the compressible seal material to at least partially cure, before removing the filter media with attached seal from the receptacle.

29. The method of claim 27, further comprising:
adding an additional amount of resin in the receptacle, prior to forming the seal, to form an elongated seal support ring extending from the layer of resin and having an axial length greater than the filled portion of each of the unplugged flutes; and
providing a sufficient time for the additional amount of resin to at least partially cure, prior to forming the seal attached to the seal support ring of the layer of resin.

30. The method of claim 27, further comprising securing alternating layers of a face sheet material and a convoluted filter material to one another with adhesive beads disposed on both sides of the layers of convoluted filter material, with the glue beads sized for securing the convoluted layers to the adjacent layers of face sheet material without blocking flow through the flutes.
